(19) United States
(12) Patent Application Publication
(10) Pub. No.: US 2004/0022509 A1
(43) Pub. Date: Feb. 5, 2004

(54) NON-ZERO DISPERSION SHIFTED OPTICAL FIBER WITH DEPRESSED CORE HAVING LARGE EFFECTIVE AREA, LOW SLOPE AND LOW DISPERSION

(76) Inventor: Pushkar Tandon, Corning, NY (US)

Correspondence Address: CORNING INCORPORATED, SP-TI-3-1, CORNING, NY, 14831

(21) Appl. No.: 10/210,703

(22) Filed: Jul. 31, 2002

(51) Int. Cl. G02B 6/22; G02B 6/16; G02B 6/18

(52) U.S. Cl. 385/127; 385/123; 385/124

(57) ABSTRACT

An optical waveguide fiber including a centermost core segment surrounded by four other core segments. At a wavelength of about 1550 nm, the optical fiber exhibits an effective area of greater than about 50 μm², a dispersion of greater than about 4 ps/nm/km, and a dispersion slope of less than about 0.03 ps/nm²/km.

### BACKGROUND OF THE INVENTION

1. Field of the Invention

The present invention relates to non-zero dispersion shifted optical fibers (NZDSF) having low slope. More preferably, the present invention relates to NZDSF fibers having low slope and low zero dispersion wavelength.

2. Technical Background

Wavelength division multiplexing (WDM) systems have operated around the 1550 nm wavelength region, defined herein as including the C-band, which includes wavelengths between about 1525 nm to about 1565, and the L-band, which includes wavelengths between about 1565 nm to about 1625 nm. Some known fibers have a zero dispersion wavelength located outside the operation window which may help prevent nonlinear penalties such as four-wave mixing (FWM) and cross-phase modulation (XPM). However, the zero dispersion wavelength of known NZDSF fibers is typically within 100 nm of 1550 nm in order to reduce the magnitude of the dispersion of a transmitted signal in the 1550 nm operating window so as to allow longer span lengths and less frequent dispersion compensation.

Preferably, coarse wavelength division multiplexing (CWDM) systems and applications operate in the WDM 1550 nm window, i.e. in the C-and L-bands, in the S-band (between about 1450 nm and about 1525 nm), and in the 1310 nm window (between about 1280 nm and about 1330 nm).

Known fibers have optical characteristics which are suitable for operation in specific windows. For example, standard single mode transmission fibers, such as the SMF-28™ optical fiber manufactured by Corning Incorporated, have a zero dispersion wavelength at or near 1310 nm, and such fibers can perform suitably in the 1310 nm window. The dispersion exhibited by such optical fiber at 1550 nm is around 17 ps/nm/km, which is larger than the dispersion at 1550 nm of typical NZDSF fiber, and which can require frequent dispersion compensation. NZDSF optical fiber can perform suitably in the 1550 nm window. Examples of NZDSF fiber include: LEAF® fiber by Corning Incorporated which has an average zero dispersion wavelength near 1500 nm and a dispersion slope of about 0.08 ps/nm/km at about 1550 nm, Submarine LEAF® fiber by Corning Incorporated which has an average zero dispersion wavelength near 1590 nm and a dispersion slope of about 0.1 ps/nm/km at about 1550 nm, MetroCor™ fiber by Corning Incorporated which has a zero dispersion wavelength near 1650 nm, and Truewave RS™ fiber by Lucent Corporation which has a zero dispersion wavelength of about 1450 nm. However, the magnitude of the dispersion in the 1310 nm window of these NZDSF optical fibers is not low, and many NZDSF fibers have specified cable cutoff wavelengths which are greater than 1260 nm.

### SUMMARY OF THE INVENTION

The optical waveguide fiber disclosed herein preferably comprises: a centermost region extending radially outward from a centerline to a radius R₀ and having a relative refractive index percent, Δ₀% (r) with a minimum absolute value |Δ₀|_{MIN}; a first annular region surrounding the centermost region and having a positive relative refractive index percent, Δ₁% (r) with a maximum relative refractive index percent, Δ_{1,MAX}; a second annular region surrounding the first annular region and having a relative refractive index percent, Δ₂% (r), with a minimum relative refractive index percent, Δ_{2,MIN}; a third annular region surrounding the second annular region and having a non-negative relative refractive index percent, Δ₃% (r) with a maximum relative refractive index percent, Δ_{3,MAX}; a fourth annular region surrounding the third annular region and having a negative relative refractive index percent, Δ₄% (r), with a minimum relative refractive index percent, Δ_{4,MIN}; and an outer annular cladding region surrounding the fourth annular region and having a relative refractive index percent, Δ_{c}% (r). The ratio of |Δ₀(r)⊕_{MIN} divided by Δ_{1,MAX} is preferably less than 0.8, the ratio of R₀/R₁ is preferably greater than 0.1, and the optical fiber has an effective area of greater than about 50 μm² at a wavelength of about 1550 nm, a dispersion of greater than about 4 ps/nm/km at a wavelength of about 1550 nm, and a dispersion slope of less than 0.03 ps/nm²/km at a wavelength of about 1550 nm.

In one preferred embodiment, the ratio of R₀/R₁ is greater than 0.2. In another preferred embodiment, the ratio of R₀/R₁ is greater than 0.3. In yet another preferred embodiment, the ratio of R₀/R₁ is greater than 0.4. In still another preferred embodiment, the ratio of R₀/R₁ is greater than 0.5.

In one preferred embodiment, R₀>0.5 microns. In another preferred embodiment, R₀>1.0 microns. In yet another preferred embodiment, R₀>1.5 microns. In still another preferred embodiment, R₀>1.6 microns.

In one preferred embodiment, the ratio of |Δ₀(r)|_{MIN} divided by Δ_{1,MAX} is less than 0.7. In another preferred embodiment, the ratio of |Δ₀(r)|_{MIN} divided by Δ_{1,MAX} is less than 0.6. In yet another preferred embodiment, the ratio of |Δ₀(r)|_{MIN} divided by Δ_{1,MAX} is less than 0.5. In still another preferred embodiment, the ratio of |Δ₀(r)|_{MIN} divided by Δ_{1,MAX} is less than 0.25.

In a preferred embodiment, the effective area is greater than about 55 μm² at a wavelength of about 1550 nm. In another preferred embodiment, the effective area is between about 50 to 60 μm² at a wavelength of about 1550 nm.

In one preferred embodiment, the dispersion is greater than about 5 ps/nm/km at a wavelength of about 1550 nm. In another preferred embodiment, the dispersion is between about 4 and 10 ps/nm/km at a wavelength of about 1550 nm. In yet another preferred embodiment, the dispersion is between about 5 and 9 ps/nm/km at a wavelength of about 1550 nm.

In a preferred embodiment, the dispersion slope is less than 0.02 ps/nm²/km at a wavelength of about 1550 nm.

In one preferred embodiment, the optical fiber disclosed herein has a zero-dispersion wavelength of less than 1400 nm. In another preferred embodiment, the zero-dispersion wavelength is less than 1380 nm. In yet another preferred embodiment, the zero-dispersion wavelength is less than 1350 nm.

In a preferred embodiment, the optical fiber disclosed herein has a zero-dispersion wavelength between about 1350 nm and about 1400 nm. In another preferred embodiment, the zero-dispersion wavelength is between about 1350 nm and about 1400 nm. In yet another preferred embodiment, the zero-dispersion wavelength is between about 1370 nm and about 1400 nm.

In a preferred embodiment, 0>Δ_{2,MIN}≧Δ_{4,MIN}.

In a preferred embodiment, Δ_{1,MAX}>Δ_{3,MAX}≧0.

In a preferred embodiment, the first annular region extends to a radius R1 between about 3 microns and about 5 microns, and wherein Δ_{1,MAX} is less than about 0.8%.

In a preferred embodiment, the second annular region extends from the radius R₁ to a radius R₂ between about 6 microns and 10 microns, and wherein Δ_{2,MIN} is greater than about −0.4%.

In a preferred embodiment, the third annular region extends from the radius R₂ to a radius R₃ between about 11 microns and about 15 microns, and wherein Δ_{3,MAX} is less than about 0.4%.

In a preferred embodiment, the fourth annular region extends from the radius R₃ to a radius R₄ between about 20 microns and about 25 microns, and wherein Δ_{4,MIN} is less than about −0.2%.

Preferably the optical fiber described and disclosed herein allows suitable performance at a plurality of operating wavelength windows between about 1260 nm and about 1650 nm. More preferably, the optical fiber described and disclosed herein allows suitable performance at a plurality of wavelengths from about 1260 nm to about 1650 nm. In a preferred embodiment, the optical fiber described and disclosed herein is a dual window fiber which can accommodate operation in at least the 1310 nm window and the 1550 nm window.

Reference will now be made in detail to the present preferred embodiments of the invention, examples of which are illustrated in the accompanying drawings. An exemplary embodiment of a segmented core refractive index profile in accordance with the present invention is shown in each of the figures.

### BRIEF DESCRIPTION OF THE DRAWINGS

FIG. 1 is a schematic cross-sectional view of a preferred embodiment of an optical waveguide fiber in accordance with the present invention;

FIG. 2 is a schematic view of a fiber optic communication system employing an optical fiber of the present invention;

FIG. 3 shows a refractive index profile corresponding to a preferred embodiment of an optical waveguide fiber as disclosed herein;

FIG. 4 shows a refractive index profile corresponding to another preferred embodiment of an optical waveguide fiber as disclosed herein;

FIG. 5 shows a refractive index profile corresponding to another preferred embodiment of an optical waveguide fiber as disclosed herein;

FIG. 6 shows a refractive index profile corresponding to another preferred embodiment of an optical waveguide fiber as disclosed herein; and

FIG. 7 shows a refractive index profile corresponding to another preferred embodiment of an optical waveguide fiber as disclosed herein.

### DETAILED DESCRIPTION OF THE PREFERRED EMBODIMENT

Additional features and advantages of the invention will be set forth in the detailed description which follows and will be apparent to those skilled in the art from the description or recognized by practicing the invention as described in the following description together with the claims and appended drawings.

The “refractive index profile” is the relationship between refractive index or relative refractive index and waveguide fiber radius.

The “relative refractive index percent” is defined as Δ%=100×(nᵢ²−n_{c}²)/2nᵢ², where nᵢ is the maximum refractive index in region i, unless otherwise specified, and n_{c} is the average refractive index of the cladding region. In cases where the refractive index of an annular region or a segment is less than the average refractive index of the cladding region, the relative index percent is negative and is referred to as having a depressed region or depressed index, and is calculated at the point at which the relative index is most negative unless otherwise specified. In cases where the refractive index of an annular region or a segment is greater than the average refractive index of the cladding region, the relative index percent is positive and the region can be said to be raised or to have a positive index. A “downdopant” is herein considered to be a dopant which has a propensity to lower the refractive index relative to pure undoped SiO₂. A downdopant may be present in a region of an optical fiber having a positive relative refractive index when accompanied by one or more other dopants which are not downdopants. Likewise, one or more other dopants which are not downdopants may be present in a region of an optical fiber having a negative relative refractive index.

“Chromatic dispersion”, herein referred to as “dispersion” unless otherwise noted, of a waveguide fiber is the sum of the material dispersion, the waveguide dispersion, and the inter-modal dispersion. In the case of single mode waveguide fibers the inter-modal dispersion is zero.

“Effective area” is defined as:

A_{eff}=2π(∫E²rdr)²/(∫E⁴rdr),

where the integration limits are 0 to ∞, and E is the electric field associated with light propagated in the waveguide.

The term “α-profile” or “alpha profile” refers to a refractive index profile, expressed in terms of Δ(r) %, where r is radius, which follows the equation,

Δ(r)%=Δ(r₀)(1−[|r−rₒ|/(r₁−rₒ)]^{α}),

where rₒ is the point at which Δ(r)% is maximum, r₁ is the point at which Δ(r)% is zero, and r is in the range rᵢ≦r≦r_{f}, where Δ is defined above, rᵢ is the initial point of the α-profile, r_{f} is the final point of the α-profile, and α is an exponent which is a real number.

The mode field diameter (MFD) is measured using the Peterman II method wherein, 2w=MFD, and w²=(2∫E²rdr/∫[dE/dr]²rdr), the integral limits being 0 to ∞.

The bend resistance of a waveguide fiber can be gauged by induced attenuation under prescribed test conditions.

One type of bend test is the lateral load microbend test. In this so-called “lateral load” test, a prescribed length of waveguide fiber is placed between two flat plates. A #70 wire mesh is attached to one of the plates. A known length of waveguide fiber is sandwiched between the plates and a reference attenuation is measured while the plates are pressed together with a force of 30 newtons. A 70 newton force is then applied to the plates and the increase in attenuation in dB/m is measured. The increase in attenuation is the lateral load attenuation of the waveguide.

The “pin array” bend test is used to compare relative resistance of waveguide fiber to bending. To perform this test, attenuation loss-is measured for a waveguide fiber with essentially no induced bending loss. The waveguide fiber is then woven about the pin array and attenuation again measured. The loss induced by bending is the difference between the two measured attenuations. The pin array is a set of ten cylindrical pins arranged in a single row and held in a fixed vertical position on a flat surface. The pin spacing is 5 mm, center to center. The pin diameter is 0.67 mm. During testing, sufficient tension is applied to make the waveguide fiber conform to a portion of the pin surface.

The theoretical fiber cutoff wavelength, or “theoretical fiber cutoff”, or “theoretical cutoff”, for a given mode, is the wavelength above which guided light cannot propagate in that mode. A mathematical definition can be found in Single Mode Fiber Optics, Jeunhomme, pp. 39-44, Marcel Dekker, New York, 1990 wherein the theoretical fiber cutoff is described as the wavelength at which the mode propagation constant becomes equal to the plane wave propagation constant in the outer cladding. This theoretical wavelength is appropriate for an infinitely long, perfectly straight fiber that has no diameter variations.

The effective fiber cutoff is lower than the theoretical cutoff due to losses that are induced by bending and/or mechanical pressure. In this context, the cutoff refers to the higher of the LP11 and LP02 modes. LP11 and LP02 are generally not distinguished in measurements, but both are evident as steps in the spectral measurement, i.e. no power is observed in the mode at wavelengths longer than the measured cutoff. The actual fiber cutoff can be measured by the standard 2m fiber cutoff test, FOTP-80 (EIA-TIA-455-80), to yield the “fiber cutoff wavelength”, also known as the “2 m fiber cutoff” or “measured cutoff”. The FOTP-80 standard test is performed to either strip out the higher order modes using a controlled amount of bending, or to normalize the spectral response of the fiber to that of a multimode fiber.

The cabled cutoff wavelength, or “cabled cutoff” is even lower than the measured fiber cutoff due to higher levels of bending and mechanical pressure in the cable environment. The actual cabled condition can be approximated by the cabled cutoff test described in the EIA-445 Fiber Optic Test Procedures, which are part of the EIA-TIA Fiber Optics Standards, that is, the Electronics Industry Alliance—Telecommunications Industry Association Fiber Optics Standards, more commonly known as FOTP's. Cabled cutoff measurement is described in EIA-455-170 Cable Cutoff Wavelength of Single-mode Fiber by Transmitted Power, or “FOTP-170”.

A waveguide fiber telecommunications link, or simply a link, is made up of a transmitter of light signals, a receiver of light signals, and a length of waveguide fiber or fibers having respective ends optically coupled to the transmitter and receiver to propagate light signals therebetween. The length of waveguide fiber can be made up of a plurality of shorter lengths that are spliced or connected together in end to end series arrangement. A link can include additional optical components such as optical amplifiers, optical attenuators, optical isolators, optical switches, optical filters, or multiplexing or demultiplexing devices. One may denote a group of inter-connected links as a telecommunications system.

A span of optical fiber as used herein includes a length of optical fiber, or a plurality of optical fibers fused together serially, extending between optical devices, for example between two optical amplifiers, or between a multiplexing device and an optical amplifier. A span may comprise one or more sections of optical fiber as disclosed herein, and may further comprise one or more sections of other optical fiber, for example as selected to achieve a desired system performance or parameter such as residual dispersion at the end of a span.

Generally, the “physical” core of optical fiber comprises one or more segments which may be doped. The segments are physically identifiable portions of the core. At the same time, it should be understood that, optically speaking, the “optical” core is considered herein to be where about 99% of the propagated light travels within the optical fiber, wherein a portion of the propagated light could travel outside a physical core segment.

Preferably, the fibers disclosed herein are made by a vapor deposition process. Even more preferably, the fibers disclosed herein are made by an outside vapor deposition (OVD) process. Thus, for example, known OVD laydown, consolidation, and draw techniques may be advantageously used to produce the optical waveguide fiber disclosed herein. Other processes, such as modified chemical vapor deposition (MCVD) or vapor axial deposition (VAD) may be used. Thus, the refractive indices and the cross sectional profile of the optical waveguide fibers disclosed herein can be accomplished using manufacturing techniques known to those skilled in the art including, but in no way limited to, OVD, VAD and MCVD processes.

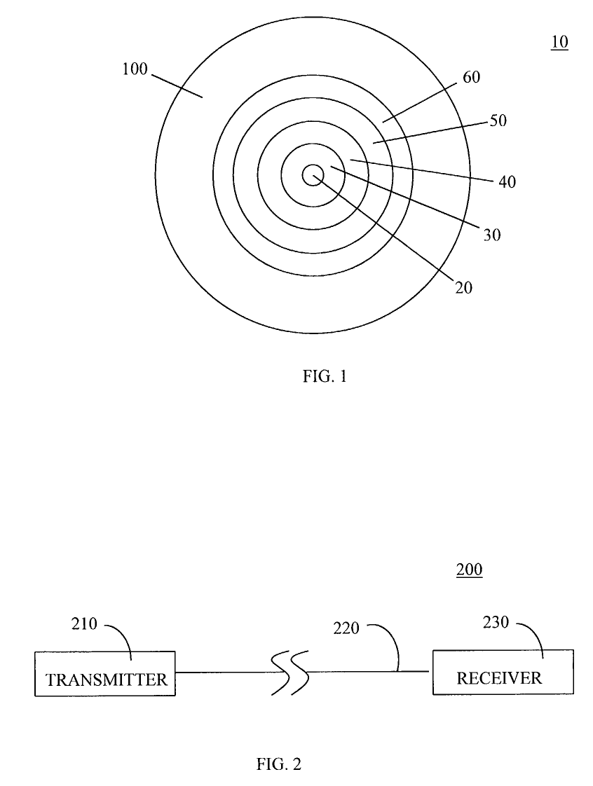

FIG. 1 is a schematic representation (not to scale) of an optical waveguide fiber 10 as disclosed herein having a centermost region (or first core segment) 20, a first annular region (or second core segment) 30 adjacent and surrounding the central region 20, a second annular region (or third core segment) 40 adjacent and surrounding the first annular region 30, a third annular region (or fourth core segment) 50 adjacent and surrounding the second annular region 40, a fourth annular region (or fifth core segment) 60 adjacent and surrounding the third annular region 50, and an outer annular cladding region or cladding or clad layer 100 adjacent and surrounding the fourth annular region 60.

The outer annular cladding region 100 may include one or more dopants. Preferably, the cladding 100 of the optical fiber disclosed herein is pure or substantially pure silica. The outer annular cladding region 100 may be comprised of a cladding material which was deposited, for example during a laydown process, or which was provided in the form of a jacketing, such as a tube in a rod-in-tube optical preform arrangement, or a combination of deposited material and a jacket. The cladding 100 is preferably surrounded by a primary coating P and a secondary coating S. The refractive index of the cladding 100 is used to calculate the relative refractive index percentage as discussed elsewhere herein.

Referring to the Figures, the clad layer 100 has a refractive index of n_{c} surrounding the core which is defined to have a Δ% (r)=0, which is used to calculate the refractive index percentage of the various portions or regions of an optical fiber or optical fiber preform.

In describing the profile of a region, a half Δ maximum point, or half-height point, can be defined by determining a peak refractive index or maximum relative index and determining what radius corresponds to a relative refractive index which is equal to one-half the value of the peak refractive index or maximum relative index, i.e. where a vertical line depending from the curve describing the relative refractive index versus radius intersects with the axis corresponding to Δ% (r)=0, i.e. the relative refractive index of the clad layer.

As shown in FIG. 2 herein, an optical fiber communication system 200 comprises an optical fiber 220 as disclosed. System 200 includes a transmitter 210 and a receiver 230, wherein optical fiber 220 allows transmission of an optical signal between transmitter 210 and receiver 230. System 200 is preferably capable of 2-way communication, and transmitter 210 and receiver 230 are shown for illustration only. The system 200 preferably includes a link which has a section or a span of optical fiber as disclosed herein. The system 200 may also include one or more optical devices optically connected to one or more sections or spans of optical fiber as disclosed herein, such as one or more regenerators, amplifiers, or dispersion compensating modules. In at least one preferred embodiment, an optical fiber communication system according to the present invention comprises a transmitter and receiver connected by an optical fiber without the presence of a regenerator therebetween. In another preferred embodiment, an optical fiber communication system according to the present invention comprises a transmitter and receiver connected by an optical fiber without the presence of an amplifier therebetween. In yet another preferred embodiment, an optical fiber communication system according to the present invention comprises a transmitter and receiver connected by an optical fiber having neither an amplifier nor a regenerator nor a repeater therebetween.

Preferably, the optical fibers disclosed herein have a low water content, and preferably are low water peak optical fibers, i.e. having an attenuation curve which exhibits a relatively low, or no, water peak in a particular wavelength region, especially the 1383 nm window. Preferably, the attenuation at 1383 nm is not greater than 0.3 dB/km over the attenuation at 1310 nm, more preferably not greater than 0.1 dB/km over the attenuation at 1310 nm, and even more preferably the attenuation at 1383 nm is less than the attenuation at 1310 nm.

A soot preform or soot body can be formed by chemically reacting at least some of the constituents of a moving fluid mixture including at least one glass-forming precursor compound in an oxidizing medium to form a silica-based reaction product. At least a portion of this reaction product is directed toward a substrate, to form a porous silica body, at least a portion of which typically includes hydrogen bonded to oxygen. The soot body may be formed, for example, by depositing layers of soot onto a bait rod via an OVD process.

A substrate or bait rod or mandrel is inserted through a glass body such as hollow or tubular handle and mounted on a lathe. The lathe is designed to rotate and translate the mandrel in close proximity with a soot-generating burner. As the mandrel is rotated and translated, silica-based reaction product, known generally as soot, is directed toward mandrel. At least a portion of silica-based reaction product is deposited on the mandrel and on a portion of a glass handle to form a soot body thereon.

Once the desired quantity of soot has been deposited on the mandrel, soot deposition is terminated and the mandrel is removed from the soot body.

Upon removal of the mandrel, the soot body defines a centerline hole passing axially therethrough. Preferably, the soot body is suspended by a handle on a downfeed device and positioned within a consolidation furnace. The end of the centerline hole remote from the handle is preferably fitted with a bottom plug prior to positioning the soot body within the consolidation furnace. Preferably, the bottom plug is positioned and held in place with respect to the soot body by friction fit. The plug is further preferably tapered to facilitate entry and to allow at least temporary affixing, and at least loosely, within the soot body.

The soot body is preferably chemically dried, for example, by exposing the soot body to a chlorine-containing atmosphere at elevated temperature within a consolidation furnace. A chlorine-containing atmosphere effectively removes water and other impurities from the soot body, which otherwise would have an undesirable effect on the properties of optical waveguide fiber manufactured from soot body. In an OVD formed soot body, the chlorine flows sufficiently through the soot to effectively dry the entire blank, including the centerline region surrounding the centerline hole.

Following the chemical drying step, the temperature of the furnace is elevated to a temperature sufficient to consolidate the soot blank into a sintered glass preform, preferably about 1500° C. The centerline hole is then closed during the consolidation step so that the centerline hole does not have an opportunity to be rewet by a hydrogen compound prior to centerline hole closure. Preferably, the centerline region has a weighted average OH content of less than about 1 ppb.

Exposure of the centerline hole to an atmosphere containing a hydrogen compound can thus be significantly reduced or prevented by closing the centerline hole during consolidation.

A glass body such as a bottom plug is positioned in the centerline hole at the end of the soot body remote from the handle, and a glass body such as hollow tubular glass plug or top plug having a open end is positioned in the centerline hole in the soot body opposite the plug. The top plug can be disposed within a cavity of a tubular handle. Following chlorine drying, the soot body is down driven into the hot zone of the consolidation furnace to seal the centerline hole and consolidate the soot body into a sintered glass preform or consolidated glass preform. Drying and consolidation may optionally occur simultaneously. During consolidation, the soot body contracts somewhat and engages the bottom plug and the lower end of the top plug, thereby fusing the resulting sintered glass preform to the plugs and sealing the centerline hole. Sealing of both the top and bottom of the centerline hole can be accomplished with one pass of the soot body through the hot zone. Preferably, the consolidated glass preform or sintered glass preform is held at an elevated temperature, preferably in a holding oven, to allow inert gas to diffuse from the centerline hole to form a passive vacuum within the sealed centerline hole. Preferably, the top plug has a relatively thin wall through which diffusion of the inert gas can more expediently occur. The top plug preferably has an enlarged portion for supporting the plug within the handle, and a narrow portion extending into the centerline hole of the soot body. The top plug also preferably includes an elongated hollow portion which may preferably occupy a substantial portion of the handle. The hollow portion provides additional volume to the centerline hole thereby providing a better vacuum within the centerline hole following diffusion of the inert gas. The volume provided by the elongated portion of the plug provides added volume to sealed centerline hole.

As described above and elsewhere herein, the bottom plug and top plug are preferably glass bodies having a water content of less than about 31 ppm by weight, such as fused quartz plugs, and preferably less than 5 ppb by weight, such as chemically dried silica plugs. Typically, such plugs are dried in a chlorine-containing atmosphere, but an atmosphere containing other chemical drying agents are equally applicable. Ideally, the glass plugs will have a water content of less than 1 ppb by weight. In addition, the glass plugs are preferably thin walled plugs ranging in thickness from about 200 μm to about 2 mm. Even more preferably, at least a portion of plug 60 has a wall thickness of about 0.2 to about 0.5 mm. More preferably still, elongated portion 66 has a wall thickness of about 0.3 mm to about 0.4 mm. Thinner walls promote diffusion, but are more susceptible to breakage during handling.

Thus, inert gas is preferably diffused from the centerline hole after the centerline hole has been sealed to create a passive vacuum within the centerline hole, and thin walled glass plugs can facilitate rapid diffusion of the inert gas from the centerline hole. The thinner the plug, the greater the rate of diffusion. A consolidated glass preform is preferably heated to an elevated temperature which is sufficient to stretch the glass preform, preferably about 1950° C. to about 2100° C., and thereby reduce the diameter of the preform to form a cylindrical glass body, such as a core cane or an optical fiber, wherein the centerline hole collapses to form a solid centerline region. The reduced pressure maintained within the sealed centerline hole created passively during consolidation is generally sufficient to facilitate complete centerline hole closure during the draw (or so-called redraw) process.

Consequently, overall lower O—H overtone optical attenuation can be achieved. For example, the water peak at 1383 nm, as well as at other OH induced water peaks, such as at 950 nm or 1240 nm, can be lowered.

A low water peak generally provides lower attenuation losses, particularly for transmission signals between about 1340 nm and about 1470 nm. Furthermore, a low water peak also affords improved pump efficiency of a pump light emitting device which is optically coupled to the optical fiber, such as a Raman pump or Raman amplifier which may operate at one or more pump wavelengths. Preferably, a Raman amplifier pumps at one or more wavelengths which are about 100 nm lower than any desired operating wavelength or wavelength region. For example, an optical fiber carrying an operating signal at wavelength of around 1550 nm may be pumped with a Raman amplifier at a pump wavelength of around 1450 nm. Thus, the lower fiber attenuation in the wavelength region from about 1400 nm to about 1500 nmn would tend to decrease the pump attenuation and increase the pump efficiency, e.g. gain per mW of pump power, especially for pump wavelengths around 1400 nm. Generally, for greater OH impurities in a fiber, the water peak grows in width as well as in height. Therefore, a wider choice of more efficient operation, whether for operating signal wavelengths or amplification with pump wavelengths, is afforded by the smaller water peak. Thus, reducing OH impurities can reduce losses between, for example, for wavelengths between about 1260 nm to about 1650 nm, and in particular reduced losses can be obtained in the 1383 nm water peak region thereby resulting in more efficient system operation.

The fibers disclosed herein are expected to have low PMD values, particularly when fabricated with OVD processes. Spinning of the optical fiber may also lower PMD values for the fiber disclosed herein.

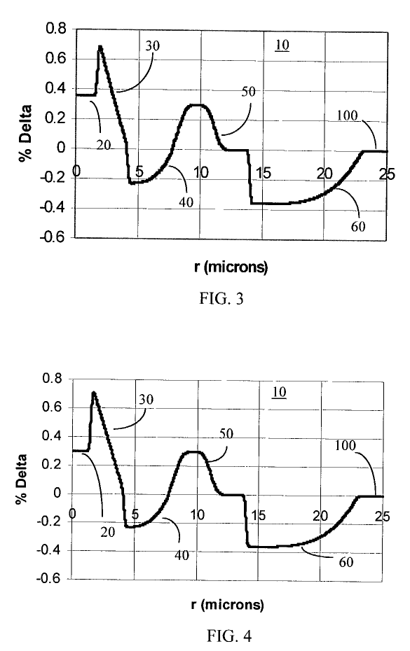

Referring to FIGS. 3-7, an optical waveguide fiber 10 disclosed herein preferably comprises: a centermost region 20 extending radially outwardly from the centerline to a centermost region outer radius, R₀, and having a relative refractive index percent, Δ₀% (r) with a minimum absolute value relative refractive index percent, |Δ₀|_{MIN}; a first annular region 30 surrounding the centermost region 20 and preferably adjacent thereto, extending radially outwardly to a first annular region outer radius, R1, having a width W₁ disposed at a midpoint R_{1mid}, and having a positive relative refractive index percent, Δ₁% (r) with a maximum relative refractive index percent, Δ_{1,MAX}; a second annular region (or moat) 40 surrounding the first annular region 30 and preferably adjacent thereto, having a width W₂ disposed at a midpoint R_{2mid}, and having a relative refractive index percent, Δ₂% (r)<0, with a minimum relative refractive index percent, Δ_{2,MIN}; a third annular region (or ring) 50 surrounding the second annular region 40 and preferably adjacent thereto, having a width W₃ disposed at a midpoint R_{3mid}, and having a relative refractive index percent, Δ₃% (r)≧0, with a maximum relative refractive index percent, Δ_{3,MAX}; a fourth annular region (or gutter) 60 surrounding the third annular region 50 and preferably adjacent thereto, having a gutter width W₄ disposed at a gutter midpoint R_{4mid}, and having a negative relative refractive index percent, Δ₄% (r)<0, with a minimum relative refractive index percent, Δ_{4,MIN}; and an outer annular cladding region 100 surrounding the fourth annular region 60 and preferably adjacent thereto and having a relative refractive index percent, Δ_{c}% (r). Preferably, Δ_{1,MAX}>Δ_{3,MAX}>0, and, preferably, 0>Δ_{2,MIN}>Δ_{4,MIN}. The ratio of the absolute value (or absolute magnitude) of Δ₀(r), |Δ₀(r)|_{MAX}, divided by Δ_{1,MAX} is preferably less than 0.8, more preferably less than 0.7, even more preferably less than 0.6, and still more preferably less than 0.5.

The centermost region 20 extends from the centerline of the fiber (r=0) to the centermost region outer radius, R₀. R₀ is defined herein as the radius where Δ₀% (r)=0.8 Δ_{1,MAX}. Preferably, centermost region 20 has a portion wherein Δ₀% (r) is substantially constant for a radial distance of at least 0.5 microns. Even more preferably, centermost region 20 has a portion wherein Δ₀% (r) is substantially constant at around Δ_{0 MIN} for a radial distance of at least 0.5 microns. In some preferred embodiments, centermost region 20 has a portion wherein Δ₀% (r) is substantially constant at around Δ_{0 MIN} for a radial distance of at least 1 micron. Preferably, the maximum deviation in Δ₀% (r) in these regions of substantially constant relative refractive index is less than 0.1, more preferably less than 0.05, even more preferably less than 0.02 (e.g. Δ₀% (r)=0.35%±0.02% or less).

The first annular region 30 extends from the R₀ to the first annular region outer radius R₁. R_{1HH} marks the radius of the half-height, or half-peak height, of Δ_{1,MAX}. The end of first annular region 30, R₁, is preferably the beginning of second annular region 40 and is defined herein to start where the relative refractive index becomes negative (i.e. where the relative refractive index profile crosses the Δ%=0 axis) at a radius greater than the radius at which Δ_{1,MAX} occurs. The first annular region 6 extends from R₀ to R₁. The width W₁ is defined as the radial distance between R₀ and R₁. The midpoint R_{1mad} occurs in the middle of R₀ and R₁.

The second annular region (or moat) 40 extends from R₁ to the second annular outer radius R₂. The width W₂ is defined as the radial distance between R₁ and R₂. The midpoint R_{2mid} occurs in the middle of R₁ and R₂. The end of second annular region 40, R₂, is preferably the beginning of the third annular region 10 and is defined herein to start where the relative refractive index reaches 0 (i.e. where the relative refractive index profile reaches the Δ%=0 axis) at a radius greater than the radius at which Δ_{2,MIN} occurs.

The third annular region (or ring) 50 extends from R₂ to the ring outer radius R₃. The ring width W₃ is defined as the radial distance between R₂ and R₃. The ring 50 has a non-negative relative refractive index profile with a “peak” or a maximum relative refractive index percent, Δ_{3,MAX}. Preferably, the relative refractive index profile of the ring 50 has a positive portion. The relative refractive index profile of the ring 50 may also comprise a leading and/or trailing portion which is substantially equal to 0%. R_{3HHi} marks the first radially inward, or most centrally disposed, occurrence of the half-height of Δ_{3,MAX}. R_{3HHj} marks the first radially outward occurrence of the half-height of Δ_{3,MAX}. The ring half-height peak width HHPW₃ is bounded by inner and outer radii, R_{3HHi} and R_{3HHj}, respectively. The midpoint of the ring half-height peak width HHPW₃ occurs at a radius R_{3HHmid} which is half the radial distance between R_{3HHi} and R_{3HHj}.

The fourth annular region (or gutter) 60 extends from R₃ to the gutter outer radius R₄. The gutter 60 is defined herein to end where the relative refractive index reaches 0 (i.e. where the relative refractive index profile reaches the Δ%=0 axis) at a radius greater than the radius at which Δ_{4,MIN} occurs. The gutter width W₄ is defined as the radial distance between R₃ and R₄. The midpoint of the gutter occurs at a radius R_{4mid}. The gutter 60 has a negative relative refractive index profile with a “peak” or a minimum relative refractive index percent, Δ_{4,MIN}.

In preferred embodiments, centermost region 20 comprises: a maximum relative refractive index or peak Δ₀%, Δ_{0,MAX}, preferably less than 0.8, more preferably less than 0.7, even more preferably less than 0.6; a minimum relative refractive index or peak Δ₀%, Δ_{0,MIN}, preferably between −0.3 and +0.4 less than 0.5; and an outer radius R₀ preferably between 0.5 and 2 microns. First annular region 30 comprises: a maximum relative refractive index or peak Δ₁%, Δ_{1,MAX}, less than 0.9, more preferably less than 0.8, even more preferably between 0.5 and 0.8, and an outer radius R₁ of between about 2 and 6 microns, more preferably between about 3 and 5 microns. Preferably, the half-peak height radius of the first annular region 30 is between about 2 and 4 microns. Preferably, the ratio of R₀/R₁ is between 0.1 and 0.5. The second annular region 40 comprises: a minimum relative refractive index or minimum Δ₂%, Δ_{2,MIN}, preferably between −0.05 and −0.40, more preferably between −0.1 and −0.3.; an outer radius R₂ of between about 6 microns and about 10 microns, more preferably at a radius of between about 7 microns and about 9 microns. Preferably, the width of the second annular region W₂ is between 2 and 6 microns, more preferably between 3 and 5 microns. Preferably, the midpoint of the second annular region R_{2,MID} is between 4 and 8 microns, more preferably between 5 and 7 microns. The third annular region 50 comprises: a maximum relative refractive index or peak Δ₃%, Δ_{3,MAX}, preferably between about 0.1 and 0.5, more preferably between about 0.2 and 0.4; and an outer radius R₃ of between about 11 microns and about 17 microns, more preferably between about 12 microns and about 16 microns. Preferably, the half height peak width of the third annular region, HHPW3, is between 1 and 6 microns, more preferably between 2 and 5 microns. Preferably, R_{3HHMID} is between 6 and 14 microns, more preferably between 8 and 12 microns. The fourth annular region 60 comprises: a minimum relative refractive index or minimum Δ₄%, Δ_{4,MIN}, preferably between −0.05 and −0.60, more preferably between −0.1 and −0.5.; an outer radius R₄ of between about 18 microns and about 30 microns, more preferably between about 20 microns and about 25 microns. Preferably, the width of the fourth annular region W₄ is between 5 and 15 microns, more preferably between 7 and 12 microns. Preferably, the midpoint of the fourth annular region R_{4,MID} is between 10 and 25 microns, more preferably between 10 and 20 microns. The outer annular cladding region or cladding segment 100 is preferably disposed adjacent and surrounding fourth annular region, and preferably begins from a radius of between about 7 microns and about 14 microns, more preferably between about 8 microns and about 13 microns. Preferably, the optical fiber 10 disclosed herein comprises five core segments: centermost region, and first, second, third, and fourth annular regions.

Referring to FIGS. 3-4, in a first aspect, the optical fiber 10 disclosed herein comprises: a centermost region 20 having a positive relative refractive index percent, Δ₀% (r) with a minimum absolute value relative refractive index percent, |Δ₀|_{MIN}; a first annular region 30 adjacent and surrounding the centermost region 20 and adjacent thereto and having a positive relative refractive index percent, Δ₁% (r) with a maximum relative refractive index percent, Δ_{1,MAX}; a second annular region (or moat) 40 adjacent and surrounding the first annular region 30 and having a negative relative refractive index percent, Δ₂% (r)<0, with a minimum relative refractive index percent, Δ_{2,MIN}; a third annular region (or ring) 50 adjacent and surrounding the second annular region 40 and having a relative refractive index percent, Δ₃% (r)≧0, with a maximum relative refractive index percent, Δ_{3,MAX}; a fourth annular region (or gutter) 60 adjacent and surrounding the third annular region 50 and having a negative relative refractive index percent, Δ₄% (r)<0, with a minimum relative refractive index percent, Δ_{4,MIN}; and an outer annular cladding region 100 adjacent and surrounding the fourth annular region 60 and having a relative refractive index percent, Δ_{c}% (r). Preferably, Δ_{1,MAX}>Δ_{3,MAX}>0, and, preferably, 0>Δ_{2,MIN}≧Δ_{4,MIN}.

The relative refractive index profiles of the optical fibers disclosed herein as illustrated in FIGS. 3-4 include respective third annular regions 50 with a trailing portion disposed radially outwardmost and having a Δ% (r) of substantially zero.

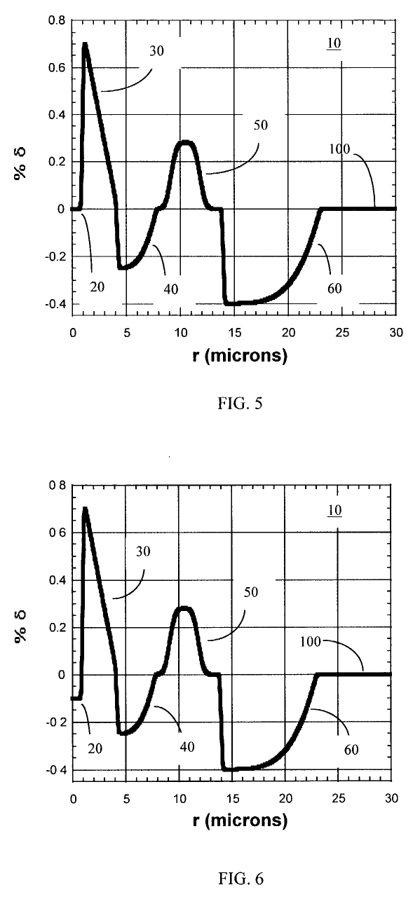

Referring to FIG. 5, in a second aspect, the optical fiber 10 disclosed herein comprises: a centermost region 20 having a non-negative relative refractive index percent, Δ₀% (r) with positive values and with a minimum absolute value relative refractive index percent, |Δ₀|_{MIN} substantially equal to zero; a first annular region 30 adjacent and surrounding the centermost region 20 and adjacent thereto and having a positive relative refractive index percent, Δ₁% (r) with a maximum relative refractive index percent, Δ_{1,MAX}; a second annular region (or moat) 40 adjacent and surrounding the first annular region 30 and having a negative relative refractive index percent, Δ₂% (r)<0, with a minimum relative refractive index percent, Δ_{2,MIN}; a third annular region (or ring) 50 adjacent and surrounding the second annular region 40 and having a relative refractive index percent, Δ₃% (r)≧0, with a maximum relative refractive index percent, Δ_{3,MAX}; a fourth annular region (or gutter) 60 adjacent and surrounding the third annular region 50 and having a negative relative refractive index percent, Δ₄% (r)<0, with a minimum relative refractive index percent, Δ_{4,MIN}; and an outer annular cladding region 100 adjacent and surrounding the fourth annular region 60 and having a relative refractive index percent, Δ_{c}% (r). Preferably, Δ_{1,MAX}>Δ_{3,MAX}>0, and, preferably, 0>Δ_{2,MIN}≧Δ_{4,MIN}. The relative refractive index profile of the optical fiber disclosed herein as illustrated in FIG. 5 includes a third annular region 50 with a leading portion, disposed radially inwardmost and having a Δ% (r) of substantially zero, and a trailing portion, disposed radially outwardmost and having a Δ% (r) of substantially zero.

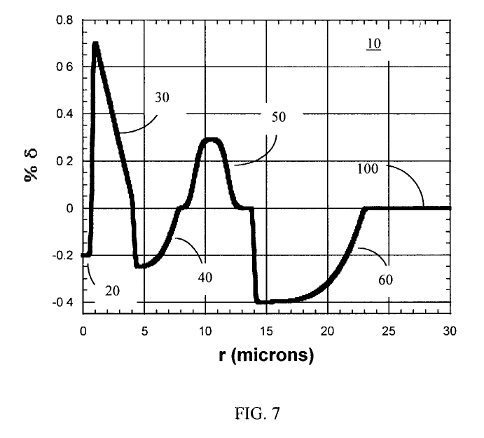

Referring to FIGS. 6-7, in a third aspect, the optical fiber 10 disclosed herein comprises: a centermost region 20 having a relative refractive index percent, Δ₀% (r), with both negative and positive values and with a minimum absolute value relative refractive index percent, |Δ₀|_{MIN}; a first annular region 30 adjacent and surrounding the centermost region 20 and adjacent thereto and having a positive relative refractive index percent, Δ₁% (r) with a maximum relative refractive index percent, Δ_{1,MAX}; a second annular region (or moat) 40 adjacent and surrounding the first annular region 30 and having a negative relative refractive index percent, Δ₂% (r)<0, with a minimum relative refractive index percent, Δ_{2,MIN}; a third annular region (or ring) 50 adjacent and surrounding the second annular region 40 and having a relative refractive index percent, Δ₃% (r)≧0, with a maximum relative refractive index percent, Δ_{3,MAX}; a fourth annular region (or gutter) 60 adjacent and surrounding the third annular region 50 and having a negative relative refractive index percent, Δ₄% (r)<0, with a minimum relative refractive index percent, Δ_{4,MIN}; and an outer annular cladding region 100 adjacent and surrounding the fourth annular region 60 and having a relative refractive index percent, Δ_{c}% (r). Preferably, Δ_{1,MAX}>Δ_{3,MAX}>0, and, preferably, 0>Δ_{2,MIN}≧Δ_{4,MIN}. The relative refractive index profiles of the optical fibers disclosed herein as illustrated in FIGS. 6-7 include a third annular region 50 with a leading portion, disposed radially inwardmost and having a Δ% (r) of substantially zero, and a trailing portion, disposed radially outwardmost and having a Δ% (r) of substantially zero.

### EXAMPLES 1 THROUGH 5

Table 1 lists the physical parameters of first through fifth embodiments (Examples 1-5) of the optical fiber disclosed herein. The relative refractive index profiles of Examples 1-5 are represented by the profiles shown in FIGS. 3-7, respectively, with the corresponding entries for the physical parameters of a particular profile being found in Table 1. Table 2 lists the optical properties of Examples 1-5. Cabled cutoff wavelength is 300 to 400 nm less than the higher of the two reported theoretical cutoff wavelengths, LP11 and LP02, and the range is listed in Table 2. Dispersion is given in units of ps/nm/km. Dispersion slope, or “slope” is given in ps/nm²/km. Pin array is given in units of dB. Spectral attenuation or attenuation is given in units of dB/km.

TABLE 1

| | Example | | | | |
|---|---|---|---|---|---|
| | 1 | 2 | 3 | 4 | 5 |
| \| Δ₀ \| _{MIN} (%) | 0.36 | 0.3 | 0.0 | 0.1 | 0.2 |
| Δ_{0 MIN} (%) | 0.36 | 0.3 | 0.0 | −0.1 | −0.2 |
| R₀ (μm) | 1.7 | 1.6 | 0.8 | 0.7 | 0.9 |
| ΔI,MAX (%) | 0.68 | 0.705 | 0.7 | 0.7 | 0.7 |
| R_{I,HH} (μm) | 3 | 3 | 2.6 | 2.6 | 26 |
| R_{I} (μm) | 4.1 | 4.1 | 4 | 4 | 4 |
| \| _{Δ}₀ \| _{MIN}/ | 0.53 | 0.43 | 0.0 | 0.14 | 0.28 |
| Δ_{I,MAX} | | | | | |
| R₀/R_{I} | 0.41 | 0.39 | 0.2 | 0.175 | 0.225 |
| Δ_{2 MIN} (%) | −0.23 | −0.23 | −0.25 | −0.25 | −0.25 |
| R₂ (μm) | 7.7 | 7.7 | 7.7 | 7.7 | 7.7 |
| W₂ (μm) | 3.6 | 3.6 | 3.7 | 3.7 | 3.7 |
| R_{2 MID (μm)} | 5.9 | 5.9 | 5.9 | 5.9 | 5.9 |
| Δ_{3 MAX} (%) | 0.30 | 0.30 | 0 28 | 0.28 | 0.28 |
| R_{3 Hhi}, (μm) | 8.3 | 8.3 | 9.2 | 9.2 | 9.2 |
| R_{3HHJ} (μm) | 11.1 | 11.1 | 11.8 | 11.8 | 11.8 |
| HHPW3 (μm) | 2.8 | 2.8 | 2.6 | 2.6 | 2.6 |
| R_{3HNMID} (μm) | 9.7 | 9.7 | 10.5 | 10.5 | 10.5 |
| R₃ (μm) | 13.7 | 13.7 | 14 | 14 | 14 |
| W₃ (μm) | 6 | 6 | 6.3 | 6.3 | 6.3 |
| Δ_{4,MIN} (%) | −0.36 | −0.36 | −0.40 | −0.40 | −0.40 |
| R₄ (μm) | 23.0 | 23.0 | 23 | 23 | 23 |
| W₄ (μm) | 9.3 | 9.3 | 9 | 9 | 9 |
| R_{4,MID} (μm) | 18.4 | 18.4 | 13.5 | 13.5 | 13.5 |

TABLE 2

| | Example | | | | |
|---|---|---|---|---|---|
| | 1 | 2 | 3 | 4 | 5 |
| Dispersion @ 1310 nm | −2.07 | −2.38 | −3.59 | −4.06 | −4.04 |
| Dispersion @ 1400 nm | 3.01 | 2.81 | 1.36 | 0.962 | 0.88 |
| Dispersion @ 1450 nm | 5.08 | 4.93 | 3.21 | 2.88 | 2.72 |
| Dis ersion @ 1535 nm | 7.79 | 7.68 | 5.35 | 5.21 | 4.80 |
| Dispersion @ 1550 nm | 8.2 | 8 | 5.65 | 5.57 | 5.09 |
| Dispersion @ 1565 nm | 8.62 | 8.51 | 5.95 | 5.92 | 5.38 |
| Dispersion @ 1625 nm | 10.29 | 10.16 | 7.27 | 7.48 | 6.67 |
| Slope @ 1400 nm | 0.046 | 0.047 | 0.042 | 0.043 | 0.042 |
| Slope @ 1450 nm | 0.037 | 0.037 | 0.031 | 0.033 | 0.031 |
| Slope @ 1550 nm | 0.027 | 0.027 | 0.02 | 0.023 | 0.019 |
| Slope @ 1625 nm | 0.029 | 0.028 | 0.025 | 0.029 | 0.024 |
| Kappa @ 1550 nm | 298 | 296 | 283 | 242 | 268 |
| Lambda Zero (nm) | 1343 | 1347 | 1371 | 1379 | 1380 |
| MFD @ 1550 nm (μm²) | 8.36 | 8.28 | 8.29 | 8.4 | 8.25 |
| Aeff @ 1550 nm (μm²) | 56.6 | 55.7 | 56 | 58 | 55 |
| Pin Array @ 1550 nm | 2.8 | 25 | 9.5 | 13.5 | 11 |
| Attenuation @ 1550 nm | 0.209 | 0.212 | 0.216 | 0.219 | 0.217 |
| LP11Cutoff (nm) | 1750 | 1759 | 1700 | 1630 | 1670 |
| LP02Cutoff (nm) | 1710 | 1728 | 1690 | 1640 | 1670 |
| Cabled Cutoff (nm) | 1350-1450 | 1359-1459 | 1300-1400 | 1240-1340 | 1270-1370 |

Various embodiments of the optical fiber disclosed herein could be made via OVD, PCVD, IVD, VAD, or MCVD methods, or by any other appropriate method known by the skilled artisan.

All of the optical fibers disclosed herein can be employed in an optical signal transmission system, which preferably comprises a transmitter, a receiver, and an optical transmission line. The optical transmission line is optically coupled to the transmitter and receiver. The optical transmission line preferably comprises at least one optical fiber span, which preferably comprises at least one section of optical fiber.

The system preferably further comprises at least one amplifier, such as a Raman amplifier, optically coupled to the optical fiber section.

The system further preferably comprises a multiplexer for interconnecting a plurality of channels capable of carrying optical signals onto the optical transmission line, wherein at least one, more preferably at least three, and most preferably at least ten optical signals propagate at a wavelength between about 1260 nm and 1625 nm. Preferably, at least one signal propagates in one or more of the following wavelength regions: the 1310 nm window, the 1383 nm window, the S-band, the C-band, and the L-band.

In some preferred embodiments, the system is capable of operating in a coarse wavelength division multiplex mode wherein one or more signals propagate in at least one, more preferably at least two of the following wavelength regions: the 1310 nm window, the 1383 nm window, the S-band, the C-band, and the L-band.

In one preferred embodiment, the system comprises a section of optical fiber as disclosed herein having a length of not more than 20 km. In another preferred embodiment, the system comprises a section of optical fiber as disclosed herein having a length of greater than 20 km. In yet another preferred embodiment, the system comprises a section of optical fiber as disclosed herein having a length of greater than 70 km.

In one preferred embodiment, the system operates at less than or equal to about 1 Gbit/s. In another preferred embodiment, the system operates at less than or equal to about 2 Gbit/s. In yet another preferred embodiment, the system operates at less than or equal to about 10 Gbit/s. In still another preferred embodiment, the system operates at less than or equal to about 40 Gbit/s. In yet another preferred embodiment, the system operates at greater than or equal to about 40 Gbit/s.

It is to be understood that the foregoing description is exemplary of the invention only and is intended to provide an overview for the understanding of the nature and character of the invention as it is defined by the claims. The accompanying drawings are included to provide a further understanding of the invention and are incorporated and constitute part of this specification. The drawings illustrate various features and embodiments of the invention which, together with their description, serve to explain the principals and operation of the invention. It will become apparent to those skilled in the art that various modifications to the preferred embodiment of the invention as described herein can be made without departing from the spirit or scope of the invention as defined by the appended claims.

What is claimed is:

1. An optical waveguide fiber comprising:
a centermost region extending radially outward from a centerline to a radius R₀ and having a relative refractive index percent, Δ₀% (r) with a minimum absolute value |Δ₀|_{MIN};
a first annular region surrounding the centermost region and having a positive relative refractive index percent, Δ₁% (r) with a maximum relative refractive index percent, Δ_{1,MAX};
a second annular region surrounding the first annular region and having a relative refractive index percent, Δ₂% (r), with a minimum relative refractive index percent, Δ_{2,MIN};
a third annular region surrounding the second annular region and having a non-negative relative refractive index percent, Δ₃% (r) with a maximum relative refractive index percent, Δ_{3,MAX};
a fourth annular region surrounding the third annular region and having a negative relative refractive index percent, Δ₄% (r), with a minimum relative refractive index percent, Δ_{4,MIN}; and
an outer annular cladding region surrounding the fourth annular region and having a relative refractive index percent, Δ_{c}% (r);
wherein the ratio of |Δ₀(r)|_{MIN} divided by Δ_{1,MAX} is less than 0.8;
wherein the ratio of R₀/R₁ is greater than 0.1; and
wherein the optical fiber has an effective area of greater than about 50 μm² at a wavelength of about 1550 nm, a dispersion of greater than about 4 ps/nm/km at a wavelength of about 1550 nm, and a dispersion slope of less than 0.03 ps/nm²/km at a wavelength of about 1550 nm.

2. The optical waveguide fiber of claim 1 wherein the ratio of R₀/R₁ is greater than 0.3.

3. The optical waveguide fiber of claim 1 wherein the ratio of R₀/R₁ is greater than 0.5.

4. The optical waveguide fiber of claim 1 wherein R₀>0.5 microns.

5. The optical waveguide fiber of claim 1 wherein R₀>1.0 microns.

6. The optical waveguide fiber of claim 1 wherein R₀>1.5 microns.

7. The optical waveguide fiber of claim 1 wherein the ratio of |Δ₀(r)|_{MIN} divided by Δ_{1,MAX} is less than 0.7.

8. The optical waveguide fiber of claim 1 wherein the ratio of |Δ₀(r)|_{MIN} divided by Δ_{1,MAX} is less than 0.5.

9. The optical waveguide fiber of claim 1 wherein the ratio of |Δ₀(r)|_{MIN} divided by Δ_{1,MAX} is less than 0.25.

10. The optical waveguide fiber of claim 1 wherein the effective area is greater than about 55 μm² at a wavelength of about 1550 nm.

11. The optical waveguide fiber of claim 1 wherein the effective area is between about 50 to 60 μm² at a wavelength of about 1550 nm.

12. The optical waveguide fiber of claim 1 wherein the dispersion is greater than about 5 ps/nm/km at a wavelength of about 1550 nm.

13. The optical waveguide fiber of claim 1 wherein the dispersion is between about 4 and 10 ps/nm/km at a wavelength of about 1550 nm.

14. The optical waveguide fiber of claim 1 wherein the dispersion is between about 5 and 9 ps/nm/km at a wavelength of about 1550 nm.

15. The optical waveguide fiber of claim 1 wherein the dispersion slope is less than 0.02 ps/nm²/km at a wavelength of about 1550 nm.

16. The optical waveguide fiber of claim 1 wherein Δ_{1,MAX}>Δ_{3,MAX}≧0.

17. The optical waveguide fiber of claim 1 wherein 0>Δ_{2,MIN}≧Δ_{4,MIN}.

18. The optical waveguide fiber of claim 1 wherein the first annular region extends to a radius R1 between about 3 microns and about 5 microns, and wherein Δ_{1,MAX} is less than about 0.8%.

19. The optical waveguide fiber of claim 18 wherein the second annular region extends from the radius R₁ to a radius R₂ between about 6 microns and 10 microns, and wherein Δ_{2,MIN} is greater than about −0.4%.

20. The optical waveguide fiber of claim 19 wherein the third annular region extends from the radius R₂ to a radius R₃ between about 11 microns and about 15 microns, and wherein Δ_{3,MAX} is less than about 0.4%.

21. The optical waveguide fiber of claim 20 wherein the fourth annular region extends from the radius R₃ to a radius R₄ between about 20 microns and about 25 microns, and wherein Δ_{4,MIN} is less than about −0.2%.
